(19) United States
(12) Patent Application Publication
(10) Pub. No.: US 2010/0319790 A1
(43) Pub. Date: Dec. 23, 2010

(54) USABLE WATER USAGE DEVICE

(76) Inventor: Franz-Josef Fleckner, Neu Wulmstorf (DE)

Correspondence Address: MARLANA TITUS, 6005 RIGGS ROAD, LAYTONSVILLE, MD, 20882, US

(21) Appl. No.: 12/736,001

(22) PCT Filed: Mar. 5, 2008
(86) PCT No.: PCT/DE2008/000365

§ 371 Date: Aug. 30, 2010

(51) Int. Cl. F16L 53/00

(52) U.S. Cl. 137/334

(57) ABSTRACT

The invention relates to a method of using tap water intended for an outflow (4), in that a water-dispensing valve (58) is opened and the temperature of the tap water flowing out of the water-dispensing valve (58) is increased by a heating means, wherein the increasing temperature of the tap water is measured with a temperature-measuring device (14) and the tap water flowing out of the water-dispensing valve (58) is first conveyed into an intermediate tank (26) by way of a supply (22, 24, 38), and the outflow (4) for the tap water is opened as soon as the tap water flowing out of the water-dispensing valve (58) has reached a minimum temperature and the supply (22, 24, 38) to the intermediate tank (26) is interrupted.

The invention relates to a method of using tap water, the temperature of which is increased by a heating means switched on after a dispensing valve has been opened.

In addition, the invention relates to a device for using tap water, the temperature of which is increased by a heating means switched on after a dispensing valve has been opened.

In view of the constantly increasing demands made upon the water supply with respect to the quantity and the quality of the water to be consumed and the development of new sources of water which lags behind this requirement, the prices for water are constantly rising. The call to develop new sources of water is becoming ever more strident. In this case the recovery of water already being tapped by multiple usage is attracting attention increasingly clearly.

Major problems arise in the recycling of water which has already been used. They are solved by considerable conversion measures having to be carried out, in particular in bathrooms. In this case a multiplicity of new lines and pipes have to be laid, so that an expensive installation outlay has to be made. In many cases extensive conversion measures have to be carried out on a house.

The object of the present invention is therefore, in a first aspect, to provide a method by which tap water can be saved. In a second aspect the object of the invention is to provide a device by which the method according to the invention can be performed.

This object is attained in the first aspect thereof by a method with the features of claim 1.

The background of the invention is the observation that, according to the prior art, cold water flows first of all out of the water-dispenser valve, which has just been opened and which can be provided on a washbasin, even if the hot-water line has been opened. When brushing one's teeth or the like above the washbasin, as a rule the user waits until the water flowing out has reached a minimum temperature. Until the minimum temperature has been reached, the cold tap water runs unused into the outflow. According to the invention this tap water, which is too cold for brushing the teeth, washing or the like but which is clean, is collected in an intermediate tank and is preferably passed on for a different use.

After a desired minimum temperature has been reached, a supply to the intermediate tank is closed and the outflow for the tap water is opened. The hot tap water is used for brushing the teeth, washing or the like and becomes dirty in the process and has to be passed on to the outflow, which is preferably connected to a sewerage system.

With this method, water for domestic use which is only slightly dirty is temporarily stored in the intermediate tank. Hitherto this water has been unthinkingly directed into an outflow, namely until the water flowing out of the tap after the hot-water valve has been opened has reached a temperature which is desired by the respective user. As a result, highly processed drinking water goes to waste. As a result of collecting this water in the intermediate tank, this slightly dirty water for domestic use can be made usable for purposes for which usually fresh water would have to be tapped. The storage in the intermediate tank can be carried out without difficulty, since the stored water has a pure drinking-water quality and does not therefore give rise to unpleasant odours.

The method takes place substantially automatically. The users of the temporarily stored water can rapidly adapt their washing and bathing habits to the method steps. The savings in valuable drinking water have the result of quickly paying for the installation components required.

In accordance with a preferred embodiment of the invention the water collected in the intermediate tank is conveyed to a cistern of a water-flushing system. This cistern is actuated in the usual way, without the user being aware of the provenance of the flushing water. In this case the intermediate tank has sufficiently large dimensions for enough water to be available for flushing a toilet for regular requirements.

In accordance with a further preferred embodiment of the invention the filling level in the intermediate tank is monitored. In this way it is made possible for the intermediate tank to be filled to the limit of its holding capacity with tap water, which for example is introduced into the cistern in order to flush the toilet. On the other hand there is no need to worry that an upper filling level of the intermediate tank will be exceeded so as to give rise to the risk that the water will flood the enclosing bathroom. Before this overfilling occurs, a valve to an outflow is opened, out of which the water flowing into the intermediate tank is diverted to a sewerage system.

In accordance with a further preferred embodiment of the invention, if a lower filling level in the intermediate tank is not reached and if the cistern is emptied at the same time, tap water is fed into the intermediate tank from a water-supply system. The tap water fed in passes from the intermediate tank into the cistern, so that the latter is never without flushing water.

In accordance with a further preferred embodiment of the invention all the functions of the supply of tap water are controlled centrally. To this end, a relatively small control apparatus is sufficient, which is installed inside the bathroom and as a rule is controlled fully automatically. Only in the event of a failure of the control means does a control means capable of being operated by the user intervene in an emergency. The user can intervene in the procedure of the process as a whole with the aid of the central control means and in this way can ensure a smooth procedure of a flushing action even in the event of failure which may possibly occur.

The object is attained in its second aspect by a device with the features of claim 13.

A temperature-measuring device is provided in the tap-water supply of a water-dispenser valve which can be arranged above a washbasin. The temperature-measuring device acts upon a control unit for a guiding device with the measurement values thereof. When a measured minimum temperature is exceeded, the control unit switches the guiding device from the supply into the intermediate tank to the outflow.

In a preferred embodiment of the invention the guiding device has a stop valve—capable of being controlled by the control unit—in a pipe of the outflow. A flange for the supply to the intermediate tank is arranged upstream of the stop valve in the direction of flow. As a result of the stop valve being closed, a dynamic pressure, by which the tap water is fed into the supply into the intermediate tank, is automatically formed upstream by the tap water flowing off.

After the minimum temperature measured by the temperature-measuring device has been reached, the control unit opens the stop valve, and the tap water used for brushing the teeth, washing or the like and therefore dirty is fed into the outflow.

When the hot-water line and the cold-water line are separate the temperature-measuring device is advantageously arranged on the hot-water supply. It can be combined with a flowmeter device there.

In an inexpensive design the guiding device is designed in the form of a pipe member with a stop valve and with a flange—starting from the pipe member wall facing away from the floor in the assembled state—for the supply.

The device facilitates its installation with respect to its advantageous design and simple usability. Many water consumers will therefore benefit from the advantages of this device and will thus reduce their consumption of drinking water. The device does not make any undue demands upon its user, who is aware of the opportunity of saving water with the aid of the device.

With a device of this type the use of tap water is particularly inexpensive, since components which can be purchased off the shelf and can be assembled in an easy manner are used in the device. The device produced as a result changes the appearance of the bathroom to only an insignificant degree since it can be installed in a small space and can be advantageously housed in already existing fixtures of the bathroom, for example in a bathroom cabinet provided below the washbasin. Since the latter is arranged below the washbasin, an intermediate tank provided in it can be filled by the water running off on account of its gravity.

In terms of the device a pump for conveying the water is arranged between the intermediate tank and the cistern. This pump is designed in the form of an underwater pump, so that it can be housed inside the intermediate tank and therefore requires no additional installation space. These pumps are highly robust and perform their tasks without significant breakdowns.

In accordance with a further preferred embodiment of the invention filling-level sensors are provided in the cistern in order to control the outflow of water from the intermediate tank. Accordingly, if the water level in the cistern drops below a specific mark, the underwater pump is actuated as a result, so that the latter can pump water out of the intermediate tank into the cistern.

In accordance with a further preferred embodiment of the invention filling-level sensors, which when the intermediate tank is empty activate a control means for the supply of tap water to the intermediate tank, are provided in the intermediate tank. If in an unlikely case sufficient tap water has not flowed into the intermediate tank before the switch-over of the flow of water takes place, then if necessary the intermediate tank can also be filled again by being directly coupled to a water-supply system. In this way there is always sufficient water to supply the cistern in the intermediate tank.

In accordance with a further preferred embodiment of the invention the control means for the supply of tap water is designed in the form of a float switch. Float switches of this type are known from numerous cisterns and have a high level of development. In this way, refilling of the intermediate tank with a high degree of operational reliability is provided.

In accordance with a further preferred embodiment of the invention the float switch is locked mechanically in the normal case of the tap-water supply. In this way, water from the water-supply system is prevented from being introduced prematurely into the intermediate tank without this being necessary. The locking, however, is controlled by a servo-motor which is switched on only when there is a need for flushing water both in the cistern and in the intermediate tank.

In accordance with a further preferred embodiment of the invention it is possible to intervene manually in the central control means of the device. If problems arise in control procedures which take place automatically, therefore, they can easily be overcome by manual intervention. In this case, in accordance with a further preferred embodiment of the invention light-emitting diodes are provided in order to display the switching positions of the stop valve.

Further details of the invention are given in the following detailed description and the accompanying drawings in which a preferred embodiment of the invention is illustrated by way of example. In the drawings

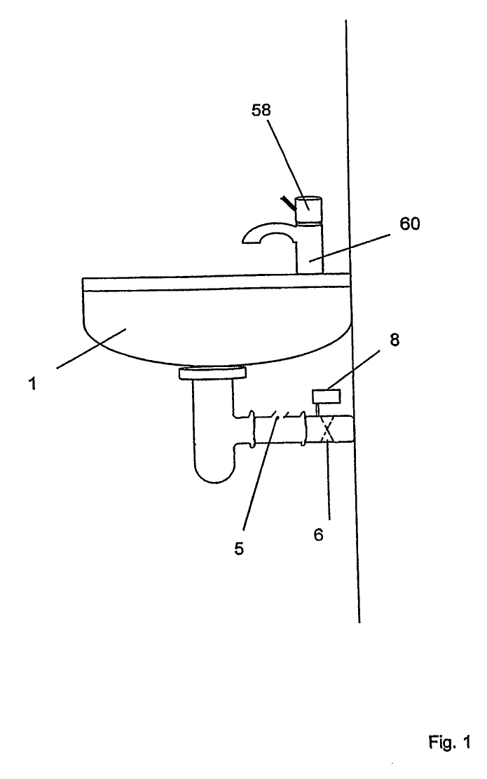

FIG. 1 is a diagrammatic illustration of a washbasin with a pipe section with a flange and a stop valve upstream of the outflow, and

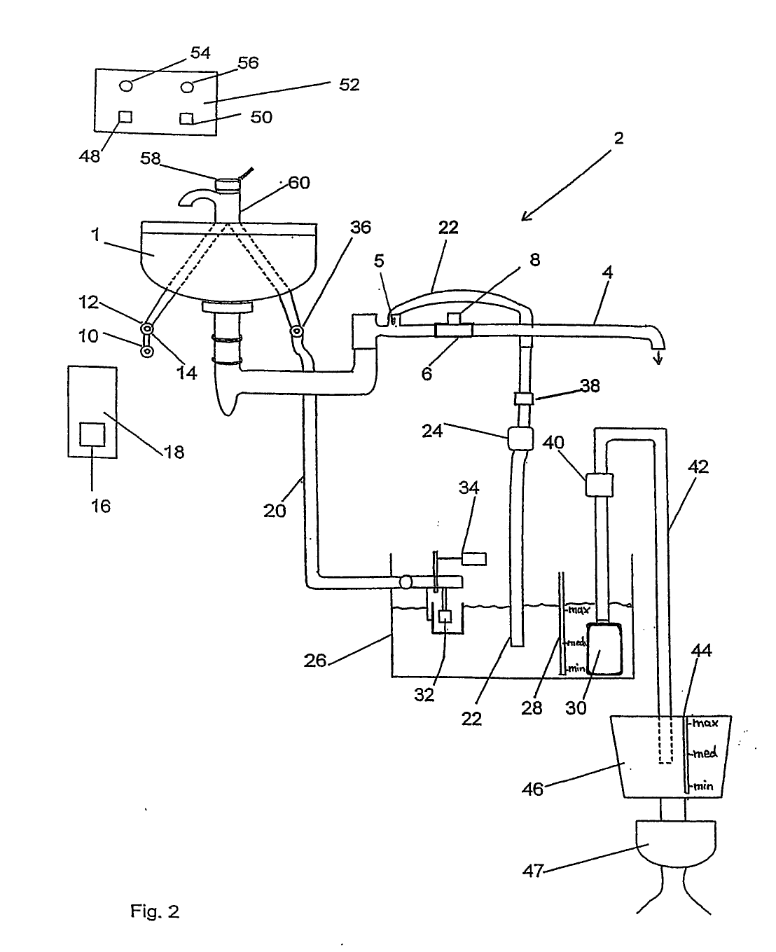

FIG. 2 is a diagrammatic illustration of a plant for making use of tape water.

A method of making use of tap water is explained first of all with reference to a device 2 for using service water illustrated in FIG. 2. With the aid of this device 2 for using service water, service water is conveyed out of a washbasin 1 into a flush toilet for re-use. The washbasin 1 is connected to a waste-water line 4 by way of a pipe section with a flange 5. The waste-water line 4 has a stop valve 6 which can be opened and closed by means of a servo-motor 8. The flange 5 is connected to a hose 22. The hose 22 opens into an intermediate tank 26 in which service water can be temporarily stored. In this case the flange 5 for the hose 22 is provided in such a way that service water can enter the hose 22 only as a result of a dynamic pressure which builds up in the waste-water line 4. If the waste-water line 4 is therefore closed when the stop valve 6 is closed, a dynamic pressure will build up upstream of the stop valve 6 and will be discharged by way of the hose 22 in the direction of the intermediate tank 26.

The servo-motor 8 by which the stop valve 6 is actuated is controlled with the aid of a temperature sensor 14 which is provided in the region of a hot-water flow entering the washbasin 1. This hot-water flow is detected by a flow monitor 12 which is provided in the region of a hot-water stop cock 10. The flow of water passes into this hot-water stop cock 10 out of a commercially available water heater which is not shown. This has a heating means by which the flow of water leaving the water heater is heated, as soon as a hot-water dispensing valve 58 provided in the washbasin 1 is opened. After the hot-water dispensing valve 58 has been opened, the heating means (not shown) of the water heater (likewise not shown) is switched on automatically by the hot-water flow produced by the water heater. As a result, the tap-water flow starts to be heated, but it reaches a desired temperature only after a certain lead time, until the heating means (not shown) has developed the heat energy required for heating the tap water.

FIG. 2 is a side view of the device according to the invention. In this case a pipe section with a flange 5 is incorporated into the conventional outflow pipe. The pipe section branches into the waste-water line 4 into a public sewerage system and into a hose 22 passing out of the flange 5 to the intermediate tank 26.

During this period of heating, the stop valve 6 keeps the waste-water line 4 closed, so that the dynamic pressure which is discharged into the intermediate tank 26 by way of the hose 22 can build up in the pipe section 5. Only after the temperature sensor 14 has detected the heating means of the flow of water and has produced a corresponding signal, is the servo-motor 8 actuated with the aid of the signal, so that it can open the waste-water line 4, out of which the service water can flow off into a waste-water outflow (not shown). As a result the dynamic pressure in the waste-water line 4 is reduced, and thus the tube 22 is separated from the further water supply.

A control unit 16, which for example can have a microprocessor (not shown), is connected to the servo-motor 8, the flow monitor 12 and the temperature sensor 14 by lines (not shown). This control unit 16 is housed in a housing 18 which is water-tight or is protected against splashing water. The control unit 16 is supplied from a mains supply (not shown).

In addition, the washbasin 1 is provided with a cold-water supply. This can be controlled together with the hot-water supply by way of a single-lever mixing fitting 60 to which the cold water flows from a cold-water wall stop cock 36. In addition, a pressure line 20 by way of which a float switch 32 is connected to the cold-water supply is connected to this cold-water wall stop cock 36. This float switch 32 is arranged in the intermediate tank 26 and is optionally used to fill the intermediate tank 26 if in a rare exceptional case insufficient water enters the intermediate tank 26 by way of the hose 22. The intermediate tank 26 is filled with cold water through the pressure line 20 when the float switch 32 opens the passage from the pressure line 20 to the intermediate tank 26. As a rule, however, the intermediate tank 26 is filled by way of the hose 22, so that the float switch 32 need not come into action in order to fill the intermediate tank 26. During this time the float switch 32 is blocked mechanically by a servo-motor 34. Only when the filling level in the intermediate tank 26 has dropped substantially and a subsequent supply of water out of the hose 22 cannot be expected in an adequate amount, is the servo-motor actuated by lines (not shown). The control commands necessary for this are generated in the control unit 16 which is connected to the servo-motor 34 by way of control lines (not shown).

An arrangement of filling-level sensors 28 is provided in the intermediate tank 26 in order to establish the filling level thereof. This arrangement measures the respective filling level at three different filling levels, namely a maximum, an intermediate and a minimum filling level. The filling-level sensors 28 are connected to the control unit 16 by way of lines (not shown). Depending upon the height of the filling level measured by the filling-level sensors 28, water is fed into the intermediate tank 26 at the lowest filling level and a further supply of water is prevented at the maximum filling level respectively.

Furthermore, an immersion pump 30 which is connected to a cistern 46 of a toilet 47 by means of a hose 42 is provided in the intermediate tank 26. Water is fed from the intermediate tank 26 into the cistern 46 by way of the hose 42. As a result, the filling level drops in the intermediate tank 26, so that water is once more fed from the waste-water line 4 into the intermediate tank 26 by way of the hose 22. In this case the waste-water line 4 is closed by the stop valve 6. The immersion pump 30 is connected to the control unit 16 by way of lines (not shown). The hose 42 is provided with a non-return valve 40, optionally in order to prevent a return flow from the cistern 46 into the intermediate tank 26 from taking place. Both the hose 42 and the intermediate tank 26 can be laid under plaster. It is also possible, however, for the intermediate tank 26 to be housed in a washbasin cabinet unit. The hose 22 can be laid together with the afore-mentioned control lines in a standard cable duct.

An arrangement of filling-level sensors 44 is provided in the cistern 46 in a manner similar to the intermediate tank 26. This arrangement too is connected to the control unit 16 by way of control lines (not shown). The filling-level sensors 44 signal a maximum, an intermediate and a minimum filling level in the cistern 46. If a minimum filling level is detected by the filling-level sensor 44, the immersion pump 30 is actuated by way of the control unit 16, so that the latter can convey water out of the intermediate tank 26 into the cistern 46. If a minimum filling level is also reported by the filling-level sensor 28 in the intermediate tank 26 at this time, however, the servo-motor 34 on the float switch 32 is actuated by way of the control unit 16. The servo-motor 34 discontinues the blocking of the float switch 32, so that water from the water-supply system is now fed directly from the cold-water wall stop cock 36 by way of the pressure line 20 into the intermediate tank 26 and from the latter by way of the immersion pump 30 into the cistern 46.

Finally, an operating unit 52, which has a “stop valve on” sensor key 48 and a “stop valve off” sensor key 50 by means of which the waste-water line 4 can be closed or opened manually, is arranged above the washbasin 1, two LEDs 54, 56 indicating the current state. To this end the operating unit 52 is connected to the control unit 16 by way of lines (likewise not shown).

If water flows into the washbasin 1 after the hot-water dispensing valve has been opened, then the flow monitor 12 detects the flow of water. As long as the water has not yet reached the temperature suitable for use, however, the temperature sensor 14 actuates the control unit 16. This has the effect that the servo-motor 8 closes the stop valve 6. As a result of the build-up pressure occurring in the waste-water line 4 the water is forced out of the flange 5 connecting the waste-water line 4 to the hose 22 and flows through the hose 22 into the intermediate tank 26.

The stop valve 6 is opened by the servo-motor 8 only when one of the following conditions is present:
the desired water temperature of for example 22° C. has been reached and has been measured by the temperature sensor 14,
water no longer flows through the hot-water line (hot-water tap has been closed),
the filling-level monitor 28 reports the maximum filling level in the intermediate tank 26,
the “stop valve off” sensor key 50 has been actuated,
after manual operation, time monitoring (for example 3 minutes) is exceeded or a failure occurs.

When the stop valve 6 is closed the intermediate tank 26 is filled until a maximum filling level has been reached, in which case this is detected by means of the filling-level sensor 28.

Alternatively, it is possible for the stop valve 6 to be opened or closed manually by means of the sensor key 48, 50, in order for example when the stop valve 6 is closed likewise to pour slightly dirty cleaning water into the intermediate tank 26 by way of the washbasin 1 or to wash the hands with cold water and likewise to convey this slightly dirty water to the intermediate tank 26. In this case the current switching states of the LEDs 54, 56 are indicated. The closed state of the stop valve 6 is also monitored with respect to time. After about 3 minutes the stop valve 6 is automatically opened if actuation of the “stop valve off” sensor key 50 has not taken place.

If the filling-level sensor 44 detects, after actuation of the flushing of the toilet, that a maximum filling level in the cistern 46 does not occur, water is pumped out of the intermediate tank 26 through the hose 42 into the cistern 46 by means of the immersion pump 30, until the maximum filling level is reached or the intermediate tank 26 is empty.

If the intermediate tank 26 is empty, the following occurs in a manner dependent upon the filling level of the cistern 46: a half-full cistern 46 is perfectly adequate for a flush. Therefore, as long as a minimum filling level in the cistern 46 is not detected, the servo-motor 34 is not switched on which in the state of rest holds the arm of the float switch 32 at the top in a manner dependent upon the filling level in the intermediate tank 26. After the servo-motor 34 is switched on, it makes a 90° turn and thus releases the arm, so that the float drops down and permits a supply of cold water by way of the pressure line 20. The servo-motor 34 remains switched on until the water level has risen to the intermediate filling level. The float switch 32 then stops the water supply. The servo-motor 34 is therefore switched on only when the minimum filling level is not reached in both the intermediate tank 26 and the cistern 46.

Furthermore, when the intermediate filling level of the intermediate tank 26 is reached, the servo-motor 34 is switched off again and the lever arm thereof locks the arm of the float switch 32. The immersion pump 30 starts to run again as soon as a minimum filling level in the intermediate tank 26 is reached and conveys water into the cistern 46 until an intermediate filling level is reached in the cistern 46, so that service water can continue to be collected in the intermediate tank 26 even before flushing of the toilet is carried out.

### LIST OF REFERENCES

1 washbasin
2 device for using service water
4 waste-water line
5 flange
6 stop valve
8 servo-motor
10 hot-water wall stop cock
12 flow monitor
14 temperature sensor
16 control unit
18 housing
20 pressure line
22 hose
24 non-return valve
26 intermediate tank
28 filling-level sensors
30 immersion pump
32 float switch
34 servo-motor
36 cold-water wall stop cock
38 filter
40 non-return valve
42 hose
44 filling-level sensors
46 cistern
47 toilet
48 “stop valve on” sensor key
50 “stop valve off” sensor key
52 operating unit
54 “stop valve on” LED display
56 “stop valve off” LED display
58 hot-water dispensing valve
60 single-lever mixing fitting

1-21. (canceled)

22. A method of using tap water intended for an outflow, in that a water-dispensing valve is opened and the temperature of the tap water flowing out of the water-dispensing valve is increased by a heating means, characterized in that the increasing temperature of the tap water is measured with a temperature-measuring device and the tap water flowing out of the water-dispensing valve is first conveyed into an intermediate tank by way of a supply, and the outflow for the tap water is opened as soon as the tap water flowing out of the water-dispensing valve has reached a minimum temperature and the supply to the intermediate tank is interrupted.

23. A method according to claim 22, characterized in that as a result of the outflow being closed by means of a stop valve a dynamic pressure is built up upstream of the stop valve and the tap water flowing out of the water-dispensing valve is conveyed by the dynamic pressure built up upstream of the stop valve into the supply by way of a flange arranged upstream of the stop valve in the direction of flow of the flow of water.

24. A method according to claim 22, characterized in that the tap water collected in the intermediate tank is conveyed to a consumer.

25. A method according to claim 23, characterized in that that the tap water collected in the intermediate tank is conveyed to a cistern of a water-flushing system.

26. A method according to claim 22, characterized in that the filling level in the intermediate tank is monitored.

27. A method according to claim 26, characterized in that, when an upper filling level is exceeded, water continuing to flow in is fed into the outflow.

28. A method according to claim 26, characterized in that, when a lower filling level in the cistern is not reached, water is conveyed out of the intermediate tank into the cistern.

29. A method according to claim 22, characterized in that, when a lower filling level in the intermediate tank is not reached and when the cistern is emptied at the same time, tap water is fed from a water-supply system into the intermediate tank.

30. A method according to claim 22, characterized in that all the functions of the supply of tap water are controlled centrally.

31. A device for using tap water intended for an outflow in order to carry out a method according to claim 22 with a tap-water supply for a water-dispenser valve and a heating means which is arranged in the tap-water supply and by which the temperature of the tap water flowing out of the water-dispenser valve is capable of being increased, and a water-dispenser valve, characterized by a guiding device arranged downstream of the water-dispenser valve in the direction of flow of the tap water for the tap water flowing out of the water-dispenser valve into the outflow or into a supply into an intermediate tank and a control unit and a temperature-measuring device for the tap water in the tap-water supply which acts upon the control unit with measurement values, and when a minimum temperature is not reached the guiding device guides the flow of water from the supply into the intermediate tank to the outflow.

32. The device according to claim 31, characterized in that the guiding device comprises a stop valve capable of being controlled by the control unit and a flange arranged upstream of the stop valve in the direction of flow for the supply.

33. A device according to claim 31, characterized by an intermediate tank and in that a pump for conveying the water out of the intermediate tank into a cistern of a flush toilet is arranged in the intermediate tank.

34. A device according to claim 33, characterized in that a filling-level sensor for controlling a flow of water passing from the intermediate tank into the cistern is provided in the cistern.

35. A device according to claim 31, characterized in that a filling-level sensor, which when the intermediate tank is emptied activates a control means for the supply of tap water to the intermediate tank, is provided in the intermediate tank.

36. A device according to claim 31, characterized in that the control unit is capable of being operated manually.
